(19) United States
(12) Patent Application Publication
(10) Pub. No.: US 2012/0087615 A1
(43) Pub. Date: Apr. 12, 2012

(54) Optical waveguide element

(75) Inventors: Takashi Shinriki, Chiyoda-ku (JP); Masayuki Ichioka, Chiyoda-ku (JP); Tetsuya Fujino, Chiyoda-ku (JP)

(73) Assignee: Sumitomo Osaka Cement Co., Ltd., Chiyoda-ku (JP)

(21) Appl. No.: 13/200,766

(22) Filed: Sep. 30, 2011

(30) Foreign Application Priority Data
Sep. 30, 2010 (JP) 2010-222293

(51) Int. Cl. G02F 1/025

(52) U.S. Cl. 385/2

(57) ABSTRACT

An object of present invention is to provide an optical waveguide element that suppresses damage to an optical waveguide element by a pyroelectric effect due to a reinforcement substrate.

Provided is an optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less, wherein a semiconductor layer is provided on a surface of the adhesive layer side of the reinforcement substrate.

The present disclosure contains subject matter related to that disclosed in Japanese Priority Patent Application JP 2010-222293 filed in the Japan Patent Office on Sep. 30, 2010, the entire content of which is hereby incorporated by reference.

### BACKGROUND OF THE INVENTION

1. Field of the Invention

The present invention relates to an optical waveguide element, particularly, an optical waveguide substrate in which an optical waveguide is formed on a substrate having an electro-optical effect and having a thickness of 30 μm or less, and an optical waveguide element in which the optical waveguide substrate is bonded via a reinforcement substrate and an adhesive layer.

2. Description of Related Art

Among the optical waveguide elements, in an optical modulator, for the broadband of a modulation bandwidth or a reduction in driving voltage, the substrate formed with the optical waveguide is formed to be a thin plate of about 10 μm, and an improvement in electric field efficiency or the speed matching condition is adjusted, whereby an improvement in the modulation capability of the optical modulator is promoted. Furthermore, in order to make it possible to stably manage the thinly worked substrate by a manufacturing process and in order to ensure the mechanical strength as a product, as described in Japanese Unexamined Patent Publication No. 2010-85789, an optical waveguide element is suggested which has a structure in which a reinforcement substrate is bonded to a main substrate formed as the thin plate.

Furthermore, in the main substrate formed as the thin plate, damage to the substrate due to a surge phenomenon owing to a local electric charge concentration is apt to occur. In order to prevent the damage, in Japanese Unexamined Patent Publication No. 2010-85738, it is suggested that a low dielectric constant layer is provided below an electrode formed on the main substrate. Furthermore, Japanese Unexamined Patent Publication No. 2007-101641 suggests a structure in which a conductive film is disposed at a side portion of the optical waveguide element or between the main substrate and the reinforcement substrate, whereby a charge prevention effect or the like is provided to suppress the damage to the substrate.

The technical means described in Japanese Unexamined Patent Publication No. 2010-85738 and Japanese Unexamined Patent Publication No. 2007-101641 has the chief aim of solving the problems after forming the optical waveguide element (a chip shape) via a wafer process. However, when using the main substrate or the reinforcement substrate such as lithium niobate (LN) having a high pyroelectric effect, the charge (the electric charge) is generated on the substrate surface due to the pyroelectric effect of the substrate, owing to the temperature change during a process or during an operation.

In general, in a thin main substrate and a reinforcement substrate supporting the same, the reinforcement substrate has a large volume and has a large potential difference or a high charge generation amount due to the pyroelectric effect. Furthermore, in a wafer process performed in the wafer state or the like, the wafer state has the volume larger than the optical waveguide element state (the chip shape), and the wafer state is also apt to be influenced by the charge or the like.

In the manufacturing process of the optical waveguide element, in a process after bonding the thin main substrate to the reinforcement substrate, there is a problem in that the charge accumulated in the reinforcement substrate having the large volume becomes a spark via a bonding layer or the like having the dielectric constant higher than air, causes damage to the main substrate, and lowers the yield of the product. Particularly, in an interface between the bonding layer and the reinforcement substrate, when a portion exists in which the electric resistance is lower than an outer peripheral portion thereof due to an imbalance of the thickness of the bonding layer, impurities in the bonding layer or the like, the spark runs toward the spot having the low electric resistance, and the bonding layer is seriously damaged, which is a cause of the optical loss of the optical waveguide element, or a decline in other performances or reliability.

### SUMMARY OF THE INVENTION

A problem to be solved by the present invention is to provide an optical waveguide element that solves the problem mentioned above, suppresses the damage to the optical waveguide element by the pyroelectric effect due to the reinforcement substrate even in a process of manufacturing the optical waveguide element as well as an optical waveguide element state, suppresses an electrical characteristic deterioration of the optical waveguide element, and enables an improvement of a yield rate relating to the production.

In order to solve the problem, according to the invention relating to a first aspect, there is provided an optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less, wherein a semiconductor layer is provided on a surface of the adhesive layer side of the reinforcement substrate.

According to the invention relating to a second aspect, there is provided an optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less, wherein a semiconductor layer is formed in an inner portion of the adhesive layer between the optical waveguide substrate and the reinforcement substrate.

The invention relating to a third aspect is configured so that, in the optical waveguide element according to the first or the second aspect, a volume resistivity of the semiconductor layer is lower than that of the adhesive layer and is lower than that of the reinforcement substrate.

According to the invention relating to the first aspect, there is provided an optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less, wherein a semiconductor layer is provided on a surface of the adhesive layer side of the reinforcement substrate. Thus, it is possible to disperse the charge accumulated in the reinforcement substrate, thereby preventing the spark generated by a local electric charge concentration. As a result, it is possible to suppress the damage to the optical waveguide element, thereby preventing the electrical characteristic deterioration of the optical waveguide element. In addition, after forming the semiconductor layer, since the spark from the reinforcement substrate to the optical waveguide substrate can be suppressed in the manufacturing process, the yield rate relating to the production can be improved.

According to the invention relating to the second aspect, there is provided an optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less, wherein a semiconductor layer is formed in an inner portion of the adhesive layer between the optical waveguide substrate and the reinforcement substrate. Thus, it is possible to suppress that the electric field toward the optical waveguide substrate is locally concentrated by the charge accumulated in the reinforcement substrate, whereby the spark from the reinforcement substrate to the optical waveguide substrate can be suppressed. In addition, after forming the semiconductor layer, it is possible to suppress the spark from the reinforcement substrate to the optical waveguide substrate in the subsequent manufacturing process, whereby the yield rate relating to the production can be improved.

According to the invention relating to the third aspect, since a volume resistivity of the semiconductor layer is lower than that of the adhesive layer and is lower than that of the reinforcement substrate, even if the electric charge accumulated in the reinforcement substrate is discharged, the semiconductor layer can disperse the electric charge to suppress the concentration.

### BRIEF DESCRIPTION OF THE DRAWINGS

FIG. 1 is a diagram that describes a cross-sectional structure of an optical waveguide element according to the present invention.

FIG. 2 is a diagram that describes an example of the optical waveguide element of the present invention, and shows an embodiment of a case where a concave portion exists in a reinforcement substrate.

FIG. 3 is a diagram that shows an example of the optical waveguide element of the present invention, and shows an embodiment of a case where a convex portion of the reinforcement substrate exists, and a thickness of an adhesive layer is locally thin.

FIG. 4 is a cross-sectional view that shows another embodiment of the optical waveguide element according to the present invention.

FIG. 5 is a graph that evaluates an influence (a loss of a signal electrode) of a film body to be disposed on the reinforcement substrate.

### DETAILED DESCRIPTION OF THE INVENTION

Hereinafter, an optical waveguide element of the present invention will be specifically described.

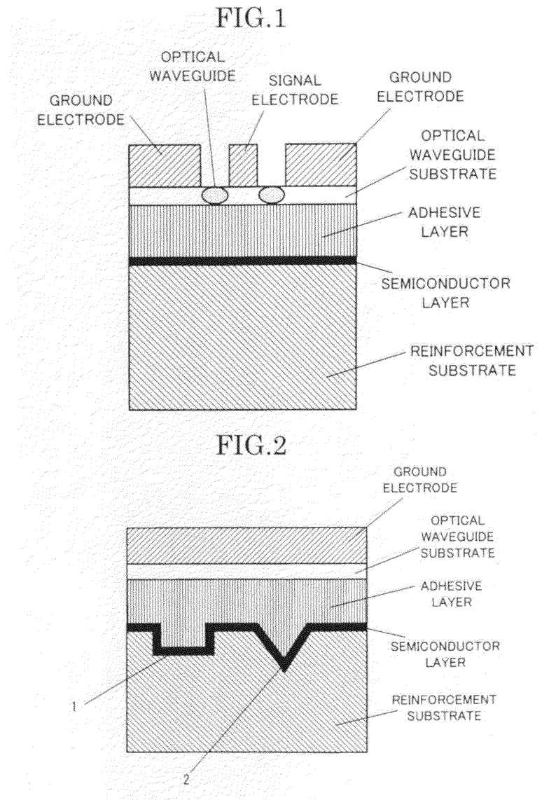

As shown in FIG. 1, according to the present invention, there is provided an optical waveguide element in which an optical waveguide substrate is bonded via a reinforcement substrate having an electro-optical effect and an adhesive layer, the optical waveguide substrate having an optical waveguide formed on a substrate having the electro-optical effect and having a thickness of 30 μm or less, wherein a semiconductor layer is provided on a surface of the adhesive layer side of the reinforcement substrate.

Furthermore, as shown in FIG. 4, according to another embodiment of the present invention, there is provided an optical waveguide element in which an optical waveguide substrate is bonded via a reinforcement substrate having an electro-optical effect and an adhesive layer, the optical waveguide substrate having an optical waveguide formed on a substrate having the electro-optical effect and having a thickness of 30 μm or less, wherein a semiconductor layer is formed in an inner portion of the adhesive layer between the optical waveguide substrate and the reinforcement substrate.

As a material having the electro-optical effect, for example, lithium niobate, lithium tantalate, PLZT (lead zirconate titanate), and combinations thereof can be used. Particularly, lithium niobate (LN) crystal having a high electro-optical effect is preferably used.

A forming method of the optical waveguide can be formed by diffusing Ti or the like on the substrate surface by a thermal diffusion method, a proton exchange method or the like. Furthermore, like Japanese Unexamined Patent Publication No. 6-289341, it is also possible to form a ridge on the surface of a thin plate 1 according to a shape of the optical waveguide and constitute the optical waveguide. In addition, it is also possible to jointly use a ridge type waveguide and a diffusion waveguide.

In the case of the optical waveguide element such as an optical modulator or an optical switch, in order to apply the electric field to the optical waveguide, a control electrode constituted by a signal electrode, a ground electrode or the like is formed on the surface or the like of the optical waveguide substrate. The control electrode can be formed by the formation of an electrode pattern of Ti.Au, a gold plating method or the like. Materials having the electro-optical effect are oxide, oxygen of that material is combined with the electrode material, and a low dielectric constant (an oxidant layer) is formed. Since gold (Au) is a material that is basically difficult to oxidize, it is desirable that a material such as Ti be included in the electrode material.

A thinning method of a main substrate (the optical waveguide substrate) constituting the optical waveguide substrate forms the optical waveguide on the substrate having the thickness of hundreds of μm, and polishes a back surface of the substrate, thereby creating a thin plate having a thickness of 30 μm or less. After that, the control electrode is formed on the surface of the thin plate. Furthermore, after forming the optical waveguide, the control electrode or the like, the back surface of the substrate can also be polished. In addition, there is a risk that the thin plate may be damaged when subjected to a thermal impact during optical waveguide formation, a mechanical impact due to the handling of the thin film during various processing or the like. Thus, it is desirable that the process, to which the thermal or mechanical impact is easily added, be performed before polishing the substrate to make the thin plate.

As shown in FIG. 1, in order to reinforce the optical waveguide substrate formed as the thin plate, a reinforcement substrate is bonded to the optical waveguide substrate via the adhesive layer. As the material used in the reinforcement substrate, various materials can be used, and, for example, in addition to the use of the material such as the main substrate formed as the thin plate, it is also possible to use a material such as quartz, glass, and alumina having a dielectric constant lower than that of the thin plate, and use a material having a crystal orientation different from the thin plate, like Japanese Unexamined Patent Publication No. 6-289341. However, it is desirable to select the material having the same line expansion coefficient as that of the thin plate so as to stabilize the modulation characteristic of the optical modulation element to the temperature change. If it is difficult to select the same material, a material having the same line expansion coefficient as that of the thin plate is selected for the adhesive bonding the thin plate and the reinforcement substrate.

The characteristic of the optical waveguide of the present invention is to suppress the charge accumulated in the reinforcement substrate from generating a spark. For this reason, when a material such as a ferroelectric substance having the electro-optical effect is used in the reinforcement material, since the pyroelectric effect is easily generated in the reinforcement substrate, particularly, the configuration of the present invention can be effectively applied.

In the bonding of the optical waveguide substrate and the reinforcement substrate, it is possible to use various bonding materials such as an epoxy-based adhesive, a thermosetting adhesive, an ultraviolet curing adhesive, a solder glass, or a thermosetting, light setting, or light thickening resin adhesive sheet, as an adhesive layer.

In the optical waveguide element of the present invention, the semiconductor layer is provided on the surface (a surface of the adhesive layer side) of the reinforcement substrate as in FIG. 1 or between the optical waveguide substrate and the reinforcement substrate as in FIG. 4. It is desirable that the volume resistivity of the semiconductor layer used in the present invention be lower than that of the adhesive layer and be lower than that of the reinforcement substrate.

By providing such a semiconductor layer, it is possible to disperse or uniformize the electric field distribution to the electric charge accumulated in the reinforcement substrate, thereby suppressing the local electric charge accumulation. By lowering the volume resistivity of the semiconductor layer than that of the reinforcement substrate, it is possible to effectively prevent that the electric charge is concentrated in a specific place of the reinforcement substrate. As in FIG. 2, when the ground electrode is disposed on the optical waveguide substrate, and the reinforcement substrate formed with an angle groove 1, a V groove 2 or the like is bonded thereto via the adhesive layer at a lower side thereof, the electric charge is apt to concentrate in an angle portion of the angle groove 1 or the V groove 2 adjacent to the optical waveguide substrate. For this reason, by disposing the semiconductor layer on the surface of the reinforcement substrate, it is possible that the spark generated from the local electric charge concentration portion may not be generated.

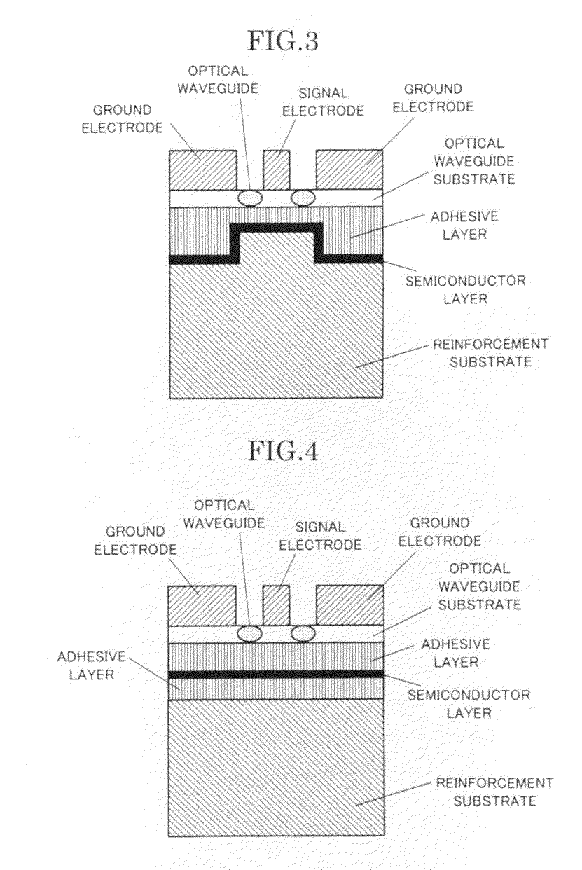

Furthermore, as shown in FIG. 3, when the reinforcement substrate having a convex portion on the surface is disposed on the optical waveguide substrate, at the upper side of the convex portion, the thickness of the adhesive layer is thinner than other portions, whereby a spark is easily generated. For this reason, by forming the semiconductor film on the surface of the reinforcement substrate, it is possible to disperse the charge accumulated in the reinforcement substrate and effectively prevent that the electric field is locally strengthened.

The semiconductor layer of the present invention not only uniformizes the charge accumulated in the reinforcement substrate as described above, but can also suppress the spark when a portion is formed in which the adhesive layer is locally and electrically easy to pass (the spark is easily generated) due to the impurities mixed in the adhesive during manufacturing procedure. This is because, by lowering the volume resistivity further than the adhesive layer, before the spark is generated in the adhesive layer, the electric charge is dispersed through the semiconductor layer, whereby it is possible to effectively prevent that the electric charge is concentrated in a specific place.

That is, like FIG. 1, by providing the semiconductor layer having the electric charge dispersion function at a side of the reinforcement substrate with which the adhesive layer comes into contact, the charge (the electric charge) is dispersed by the layer and can be uniformized in the plane, and the electric resistance is set to be lower than the adhesive layer, whereby the occurrence of the spark toward the main substrate (the optical waveguide substrate) is prevented, and the damage to the main substrate is suppressed.

In addition, as shown in FIGS. 1 to 3, without being limited to the case where the semiconductor layer directly comes into contact with the reinforcement substrate, as shown in FIG. 4, by interposing the semiconductor layer between the main substrate and the reinforcement substrate, even when the influence of the charge generated in the reinforcement substrate is applied to the semiconductor layer, the charge does not reach the main substrate, and thus, the characteristic of the optical waveguide element can be maintained.

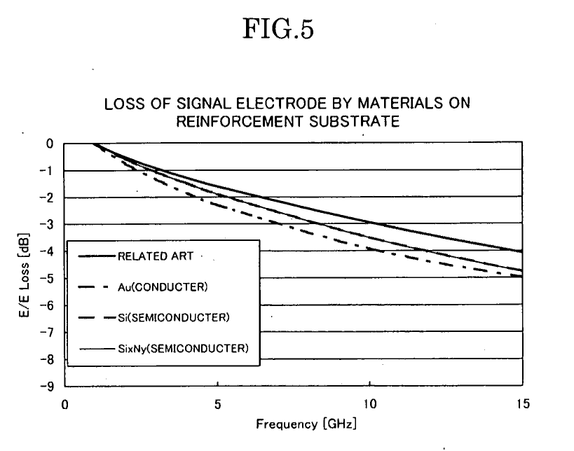

As in the semiconductor layer of the present invention, a layer having the electric charge dispersion function preferably has a lower resistance, but, if a conductor is used, the conductor affects the electric loss of the signal electrode provided at the main substrate side, which is a cause of the deterioration of the characteristic of the optical waveguide element such as an optical modulator (see FIG. 5). Thus, in the present invention, a semiconductor is used which does not easily affect the electric loss, and Si, SiₓN_{y}, SiO_{z} or the like can suitably be used as the semiconductor. However, c, y, and z are suitably adjusted in order to adjust the volume resistivity or the dielectric constant of the semiconductor.

FIG. 5 is a graph that investigates the loss of the signal electrode of a case where Au as the conductor and Si or SiₓN_{y} as the semiconductor is disposed on the surface of the reinforcement substrate. In addition, the LN substrate is used in the main substrate (thickness 8 μm) and the reinforcement substrate (thickness 500 μm) becoming the optical waveguide substrate. On the main substrate, the signal electrode and the ground electrode having height of 22 μm mare formed. The optical modulator is manufactured by using a UV photo curing adhesive or the like (volume resistivity: 1.0×10¹⁵ Ωcm, the dielectric constant: 3) as the adhesive layer (thickness 55 μm). Furthermore, at the surface side of LN coming into contact with the adhesive of the reinforcement substrate, Au is deposited, or the semiconductor of Si or SiₓN_{y} is formed by a film forming equipment such as a sputter device. As the volume resistivity of the semiconductor film of this time, the volume resistivity of the adhesive is equal to or less than 1.0×10¹⁵ Ωcm. Specifically, in the case of SiₓN_{y}, a film of 1.0×10⁹ to 1.0×10¹¹ Ωcm was formed. Furthermore, the reinforcement substrate and the main substrate formed with the semiconductor layer or the like are bonded together by an adhesive or the like. In addition, the product of the related art means a product in which the film body of the conductor or the semiconductor is not formed at all.

As shown in the graph of FIG. 5, in the product of the related art provided without any film body, the loss of the signal electrode is smallest, and when using the conductor, the loss is greater than the product of the related art. The loss difference between the product of the related art and the conductor product is greater at a high frequency side than at a low frequency side, and in the optical modulator of the broadband like the present invention, it is difficult to satisfy the characteristic with the conductor product. However, by using the semiconductor film having the function as the electric charge dispersion, it is possible to suppress the loss of the signal electrode from worsening more than the conductor, and it is possible to expect a yield improvement while maintaining an electrode loss of a level that is usable even in the broadband where the occurrence of the spark is suppressed.

Furthermore, table 1 shows a difference between a microwave refractive index (Nm) of the case of providing the product of the related art, the semiconductor, and the film of the conductor and the product of the related art. When the product of the related art satisfies the speed matching condition, of course, a smaller difference with the product of the related art means that the influence to the characteristic of the optical waveguide element is small. Thus, it is easily understood that the use of the semiconductor like the present invention effectively suppresses the characteristic deterioration of the optical waveguide element compared to the case of using the conductor.

### Table 1

### Characteristic Concerning Signal Electrode on Optical Waveguide Substrate

| | SiₓN_{y} (semiconductor) | Au (conductor) |
|---|---|---|
| | Difference Δwith product | Difference Δwith product |
| | of related art | of related art |
| Nm | 0.003 | −0.02 |

In the optical waveguide element of the present invention, by using the semiconductor layer, it is possible to suppress the damage to the main substrate due to the spark or the like, also suppress the deterioration of the electric loss of the signal electrode, and also suppress the deterioration of the characteristic of the modulation efficiency or the like due to the decline of the speed matching.

Furthermore, in order to investigate the yield in the manufacturing process, the damage to the main substrate due to the spark from the reinforcement substrate was investigated on the product of the related art and the invention using the SiₓN_{y} film. Specifically, the presence or absence of damage due to cracks, scratches or the like near the waveguide mainly relating to the optical characteristic of the main substrate was examined, and a damaged product was determined as a defective product. As a consequence, a defective product due to a manual handling or the like according to the working or the butting of the main substrate is generated at an identical defect rate in both of the product of the related art and the product of the present invention. However, it was confirmed that, in the result after performing a subsequent process such as a thermal process using the bonded substrate, the defect rate of the product of the present invention was improved by 0.6%.

As mentioned above, according to the present invention, it is possible to provide an optical waveguide element in which, even in the process of manufacturing the optical waveguide element, as well as the optical waveguide element state, it is suppressed that the optical waveguide element is damaged by the pyroelectric effect due to the reinforcement substrate, the electrical characteristic deterioration of the optical waveguide element is suppressed, and the yield rate relating to the production can be improved.

1. An optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less,
wherein a semiconductor layer is provided on a surface of the adhesive layer side of the reinforcement substrate.

2. An optical waveguide element in which an optical waveguide substrate is bonded to a reinforcement substrate having an electro-optical effect via an adhesive layer, the optical waveguide substrate having an optical waveguide formed on a substrate having the electro-optical effect and having a thickness of 30 μm or less,
wherein a semiconductor layer is formed in an inner portion of the adhesive layer between the optical waveguide substrate and the reinforcement substrate.

3. The optical waveguide element according to claim 1,
wherein a volume resistivity of the semiconductor layer is lower than that of the adhesive layer, and is lower than that of the reinforcement substrate.

4. The optical waveguide element according to claim 2,
wherein a volume resistivity of the semiconductor layer is lower than that of the adhesive layer, and is lower than that of the reinforcement substrate.
